(19) United States
(12) Patent Application Publication
(10) Pub. No.: US 2005/0229862 A1
(43) Pub. Date: Oct. 20, 2005

(54) Powder dispenser amd method for pet care

(76) Inventors: Diana Dirle, Virginia Beach, VA (US); Christopher Dirle, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/826,066

(22) Filed: Apr. 16, 2004

(51) Int. Cl. A01K 13/00

(52) U.S. Cl. 119/174

(57) ABSTRACT

A powder dispenser includes a reservoir and a removable end cap that seals an end of the reservoir. A powder measure is rotatably affixed at an opposite end of the reservoir for receiving a specific amount of powder from the reservoir. The powder measure rotates into a first position to allow the user to dip an injured dog toenail into the measure to stop blood flowing from the toenail. The powder measure rotates into a second position to for refilling the powder measure.

There are no related applications.

The application received no federal research and development funding.

### BACKGROUND OF THE INVENTION

The invention relates generally to a powder dispenser for dispensing a measured amount of powder. More particularly, the invention relates to a powder dispenser for dispensing a measured dosage of alum or styptic powder for treating a dog's toenail having an injured quick. The invention may also be used to dispense powder for cats, ferrets, or any other such animals. It may be used to apply powder to any nick, cut, small wound, wart or growth that may need styptic powder or other such treatment powder. Moreover, the invention may be filled with grooming powder and used to cover tear stains on white or light colored dogs or other animals.

Good pet hygiene is important for dogs. Trimming a dog's toenails is important for proper hygienic care and to maintain a dog's health. A clicking sound generated as a dog walks across a concrete or tile floor indicates that it is time for the dog to have his toenails trimmed. Neglected and untrimmed nails can cause a variety of problems including broken nails that are painful and may bleed profusely.

Since dog toenails include both dead skin cells and living cells, care must be taken when trimming the toenails. The living cells of the toenail are referred to as the “quick.” The quick is the pink part of the toenail in light colored toenails. However, it is difficult if not impossible to ascertain where the quick begins in a dark colored toenail. Since the quick includes small blood vessels and nerve endings, trimming the dog toenail too short or cutting into the quick causes the toenail to bleed. Likewise, small nicks or cuts occurring while grooming a matted animals coat can lead to bleeding.

Proper toenail trimming requires the trimmer to cut the dead skin cells no closer than to within 2 mm of the quick. However, many dogs wiggle or move during the toenail trimming process causing the trimmer to cut too close to or into the quick. Since it is very difficult to determine where the quick ends and the dead cells begin in dark colored toenails, this sometimes leads to cutting into the quick in animals with dark colored toenails or dogs that move during the trimming process. In fact, many pet care professionals cut toenails past the quick in order to keep the nails as short as possible for showing the animal at shows or for health reasons. When the trimmer cuts into the quick, alum or a styptic mixture containing silver nitrate is typically used to stop the blood from flowing from the injured toenail.

Previously, the bleeding toenail was treated with a styptic pencil or a bowl containing alum or a styptic powder. Use of a styptic pencil is very difficult since the pencil must be kept in contact with the damaged nail and rotated around the bleeding area. This is a very difficult task to accomplish in large dogs. When a bowl of styptic powder is used, a fair amount of styptic powder is wasted since contaminated powder cannot be reused for other dogs because of the fear of spreading of a disease. It is also very difficult to constrain a wiggling dog and dip a damaged toenail into a bowl of styptic powder.

### BRIEF SUMMARY OF THE INVENTION

The present invention is a powder dispenser including a refillable powder reservoir and a method for use thereof. The powder reservoir includes a removable cap for sealing an end of the reservoir. The groomer or trimmer removes the cap and deposits powder into the reservoir. The powder measure fills with powder supplied from the powder in the reservoir. An injured dog toenail is dipped into the powder contained within the measure.

A rotatable powder measure affixed at an end of the powder reservoir receives a measured quantity of powder from the powder reservoir. The powder measure comprises a recess having a volume for receiving a measured amount of powder from the powder reservoir. The powder measure includes circular extensions that mate with complementary holes in the walls of the powder reservoir. Thus, the circular extensions allow the measure to be rotated such that the recess is exposed to an interior of the powder reservoir that contains powder in one position for filling the powder measure and rotated into a second position for dipping the dog toenail into the powder filled recess of the measure.

In use, the powder measure rotates such that powder flows from the reservoir into and fills the recess. The filled powder measure then rotates approximately 60 to 100 degrees such that the measured dosage of powder is exposed for use. The trimmer inserts the damaged dog toenail into the measured dosage of powder contained within the recess. Blood flowing from the damaged dog toenail coagulates and stops flowing when it contacts the styptic powder. A cotton swab or other small cleaning implement cleans the recess. In a second embodiment, the powder measure is removable for cleaning purposes and filling the powder reservoir.

It is an object of the invention to provide a measured amount of styptic or other such powder for treating animals from a powder reservoir. The measured amount of powder fills the recess of the powder measure. The powder measure then rotates into an in-use position. The trimmer dips the damaged dog toenail into the measured amount of powder. Providing only a measured amount of styptic powder during the treatment process reduces waste of the powder.

It is another object of the invention to provide a refillable powder dispenser. The powder dispenser includes a powder reservoir and an end that opens for refilling the powder reservoir with powder. A powder measure is removeably affixed or hingedly affixed at an end of the powder reservoir for receiving powder therefrom.

It is a further object of the invention to provide a powder dispenser having a reservoir with extensions. A rotatable powder measure includes cylindrical extensions that mate with holes in extensions of the walls of the powder reservoir. The powder measure rotates between approximately 60 to 100 degrees between an “open” and “closed” position.

It is an additional object of the invention to provide an easily refillable powder measure. The trimmer fills the powder measure by urging the measure from an open to a closed position. In the closed position, the recess of the powder measure receives powder from the powder reservoir. The reservoir may be shaken, flicked or tapped to cause the powder to flow from the reservoir to the measure.

It is a further object of the invention to provide a powder dispenser that is easy to use. The powder dispenser includes a powder measure that is filled by rotating a recess in the measure towards the powder reservoir and allowing powder to flow into the powder measure from the powder reservoir.

It is a further object of the invention to provide a removable powder measure that can be readily cleaned. The removable powder measure may be replaced quickly by a second powder measure for treating a different animal. Thus, a single reservoir of powder may be used to treat many different animals by simply replacing the power measure. Using replaceable clean powder measures prohibits the spread of disease while reducing the amount of wasted powder.

It is an object of the invention to provide a less wasteful powder dispenser for dispensing a measured amount of powder necessary treating a damaged dog toenail. This provides a more efficient use of powder.

Additional objects and advantages of the invention will be set forth in part in the description that follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1 is a view of a dog's paw having trimmed and untrimmed dog toenails.

FIG. 2 is a perspective view of a powder dispenser in a “filling position.” The powder measure is positioned beneath the powder reservoir for receiving powder from the reservoir. The dispenser is then shaken or tapped causing powder to flow from the reservoir of the dispenser into and filling a recess in the measure.

FIG. 3 is a perspective view of the powder dispenser showing the powder measure open for use and filled with powder. The injured dog toenail is dipped into the powder contained within the measure. The measure may be quickly refilled by rotating the measure.

FIG. 4A is a front view of the powder dispenser showing the powder measure in a closed position.

FIG. 4B is an enlarged view of the end of the powder measure in an open position and taken from line A-A of FIG. 4A.

FIG. 5 is a plan view of the powder dispenser from the side with the powder measure removed and showing an extension of the sidewall.

FIG. 6 is an enlarged plan view of the side of the powder measure and showing the powder measure in an open position and showing the stop.

FIG. 7 is a perspective view of the powder measure.

FIG. 8 is a elevation view of the side of the powder measure.

FIG. 9 is a perspective view of the removable end cap in the first embodiment of the invention.

FIG. 10 is an end view of the powder reservoir.

FIG. 11 is an elevation view of a removable powder measure of the second embodiment of the invention.

### DETAILED DESCRIPTION OF THE INVENTION

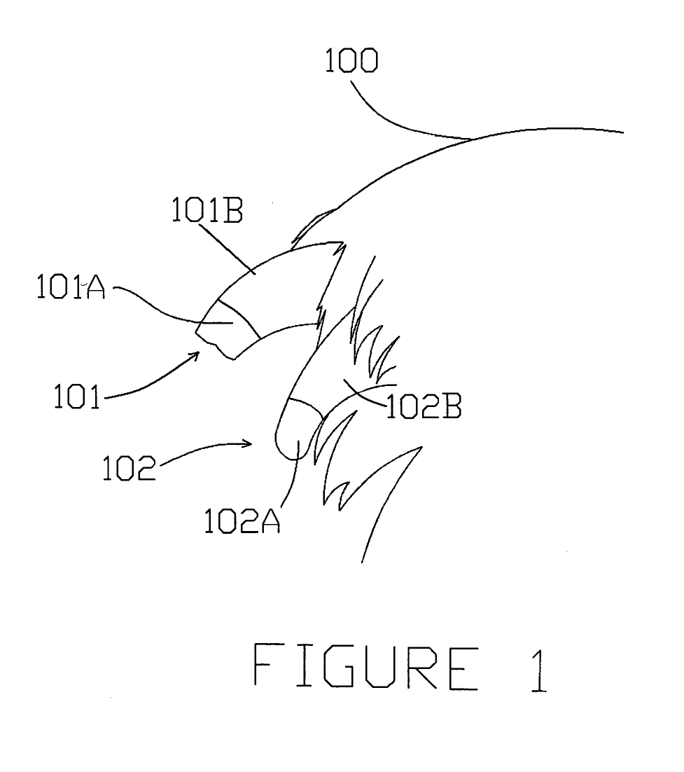

FIG. 1 shows a dog paw 100 having two toenails 101 and 102. The toenails include both living and dead cells. In Toenail 101, dead cells are denoted as 101A while living cells or “the quick” are denoted as 101B. As shown in this figure, dead cells 101A at the end of toenail 101 are correctly trimmed to within 2 mm of the quick 101B. Toenail 102 needs to be trimmed. The dead cells are denoted as 102A and the quick is denoted as 102B. If toenail 102 is a dark colored toenail, it is difficult for the trimmer to ascertain where the dead cells end and the quick begins. If the trimmer cuts into the quick, the toenail will bleed.

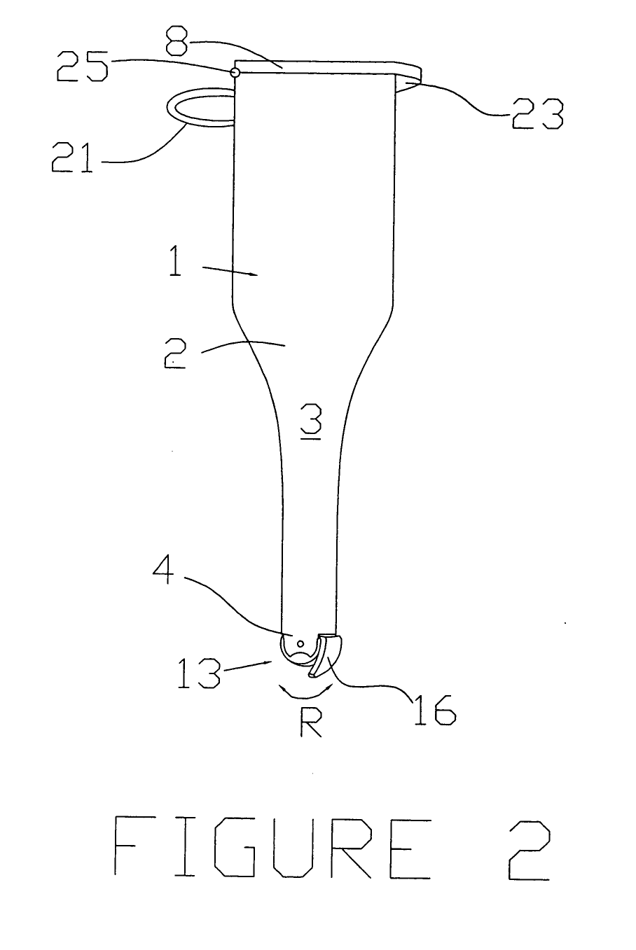

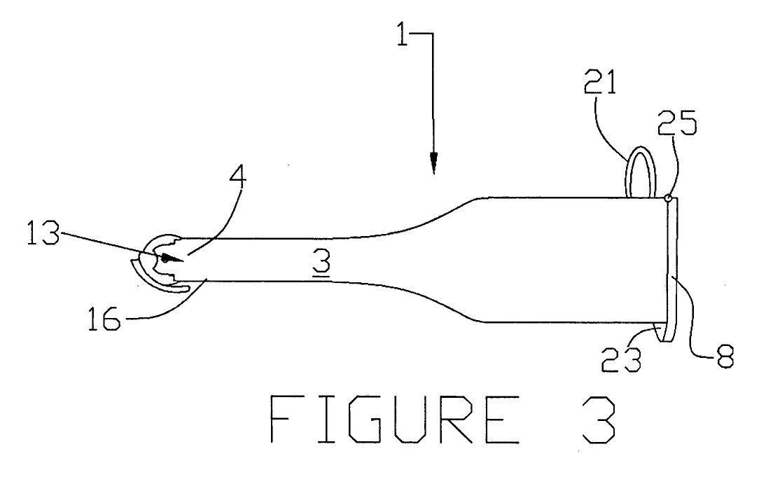

FIGS. 2 and 3 show the powder dispenser 1 with the powder measure 13 in “closed” and “open” positions, respectively. The powder dispenser 1 includes a removable end cap 8, a powder reservoir 2, and a rotatable powder measure 13. In the preferred embodiment, all parts of the powder dispenser comprise plastic or other durable and cost-effective material. Powder reservoir 2 comprises walls 3 that define the powder reservoir. The reservoir 2 is shown having a hopper style shape. The shape of the reservoir 2 is unimportant and may vary greatly. The dispenser 1 may include a hook 21 for attaching it to a lanyard.

The end cap 8 is attached to dispenser 1 via hinge 25. The end cap 8 may be opened to provide access to an interior of the powder reservoir for replenishing the powder supply of the reservoir 2. End cap 8 includes an edge 23 for providing a solid surface for pushing against to open the end cap 8. Walls 3 define reservoir 2 and may include a pocket clip on an exterior surface of the wall. The pocket clip may be similar to those included on pens. Walls 3 include extensions 4 at an end of the reservoir 2 opposite the end cap 8 and discussed hereinafter. Powder measure 13 also includes stop 16 that prevents the powder measure from over rotating. If the measure 13 is over rotated, powder may freely flow from the reservoir 2 causing powder to be wasted.

In FIG. 2, the powder measure 13 is positioned beneath powder reservoir 2 in a “closed” or “filling” position such that the measure 13 accepts powder from the reservoir 2. Arrow R shows the direction of rotation of the powder measure 13. Typically, the measure 13 rotates between 60 and 100 angular degrees from the open and closed positions.

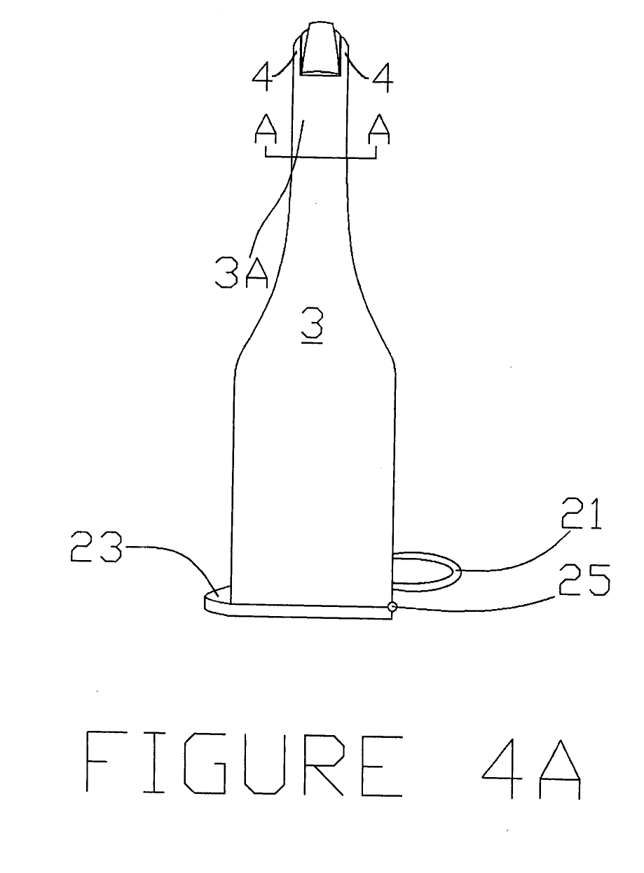

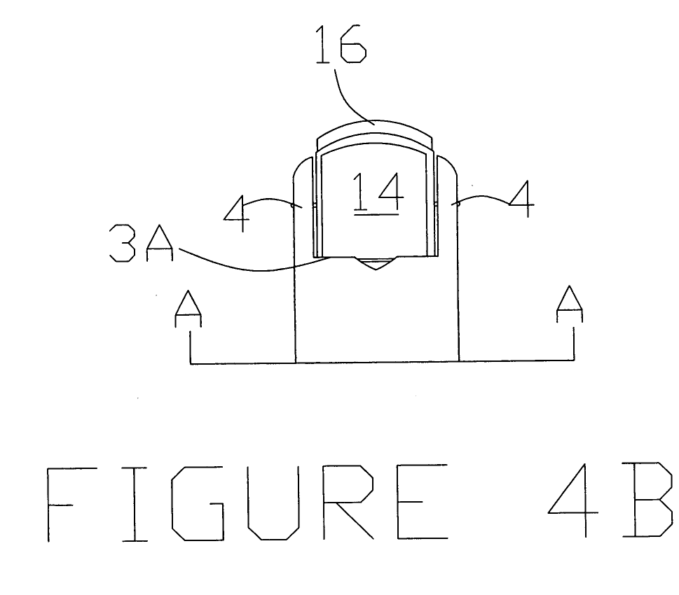

To use the dispenser 1, the toenail trimmer positions the powder measure 13 at an elevation lower than the powder reservoir 2 as shown in FIG. 2. The trimmer then shakes or taps the powder dispenser 1 causing powder from the reservoir 2 to flow into the measuring cap recess 14 (shown in FIG. 4B).

The trimmer then orients the powder dispenser as shown in FIG. 3 and rotates the stop 16 downward and in a angular manner to expose the recess 14. The powder measure 13 rotates into the open position for dipping the damaged dog toenail into the powder confined within the measure 13. As mentioned previously, stop 16 prevents the measure 13 from rotating too far in either direction and allowing powder to spill uninterrupted from the powder reservoir 2. By limiting the range of motion that the powder measure rotates, the recess 14 can be filled with powder and opened for use or cleaning.

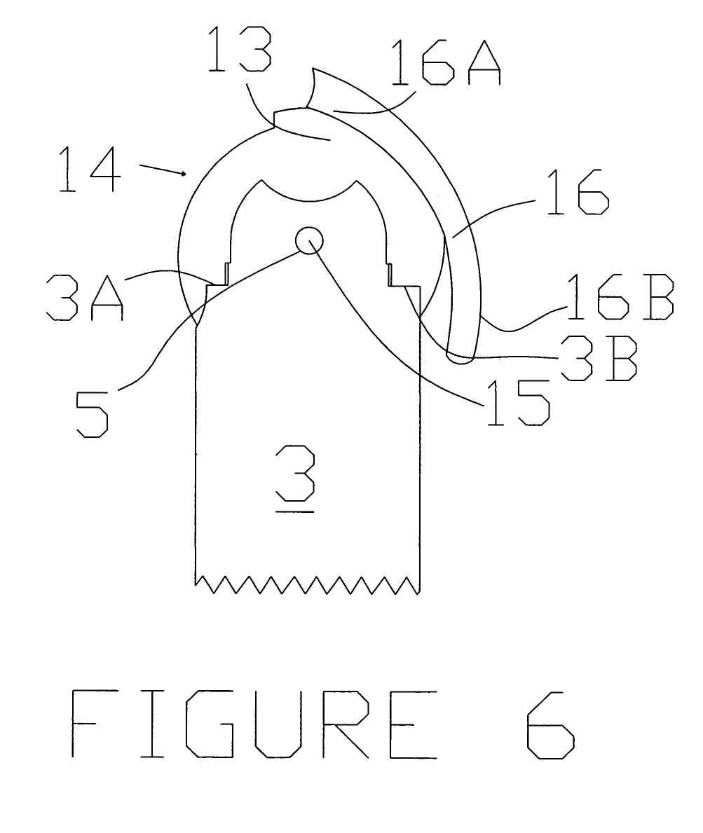

FIG. 4A is a front side view of the powder dispenser 1 showing the powder measure 13 in a closed position. An end of the stop 16 contacts a lip portion 3A of one of the walls 3 to limit the range of rotation of the powder measure 13. FIG. 4B is an enlarged view of the powder measure taken from line A-A of FIG. 4A. As shown in FIG. 4B, the walls 3 include extensions 4 on opposite sides of powder measure 13 for accepting cylindrical extensions 15 that extend from either side of the powder measure as shown in FIGS. 6 through 8.

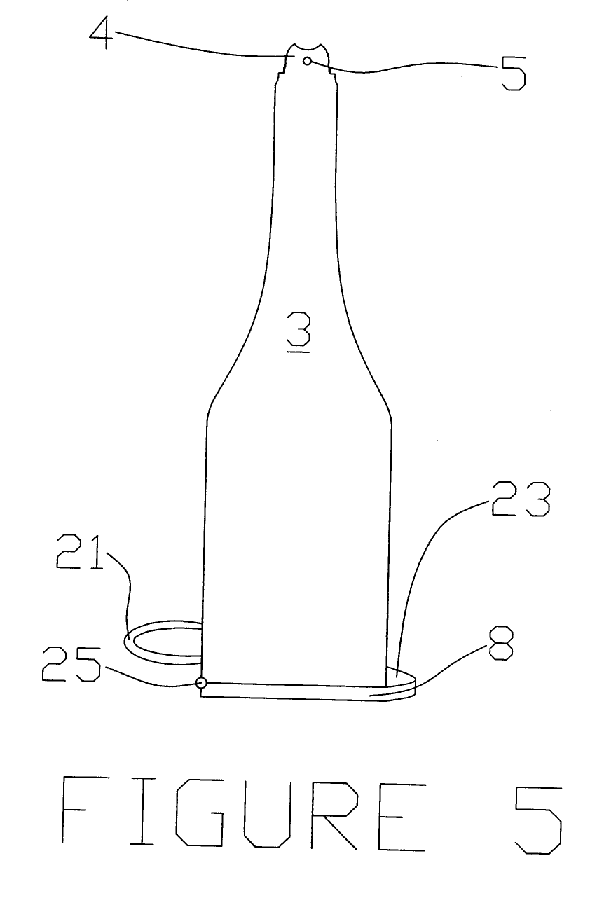

FIG. 5 is a plan view of the powder dispenser 1 showing the powder measure 13 removed therefrom. The powder dispenser 1 includes the extensions 4 that comprise circular holes 5 for receiving the cylindrical extensions 15 of the powder measure 13 as shown in FIG. 6. It should be noted that the holes 5 and cylindrical extensions 15 may be modified to allow the powder measure 13 to rotate a predetermined range of circular degrees thereby removing or obviating the need for the stop 16. That is to say, the holes 5 may comprise stops and cylindrical extensions 15 may include a portion removed therefrom for operating in a manner similar to stop 16.

FIG. 6 depicts an enlarged plan view of the powder measure 13 and a wall 3 of the powder reservoir 2. The powder measure 13 includes a stop 16 previously mentioned and discussed hereinafter. When the measure 3 is in a “closed” position, a first end 16A contacts wall surface 3A thereby preventing the powder measure 13 from allowing powder to inadvertently spill from the reservoir 2. In the closed position, recess 14 is exposed to an interior of reservoir 2 for receiving powder therefrom. A second end 16B overlaps and contacts wall surface 3B preventing the powder measure 13 from being over rotated in the “open” position as shown in this figure. By overlapping end 16B over surface 13, the powder measure 13 is held in an open position until it is biased towards a closed position by the user. It should be noted that end 16B may be modified to operate in the same manner as end 16B or visa versa. By limiting the amount of angular rotation of the powder measure 13, the powder measure 13 prevents powder from uncontrollably flowing from the reservoir 2.

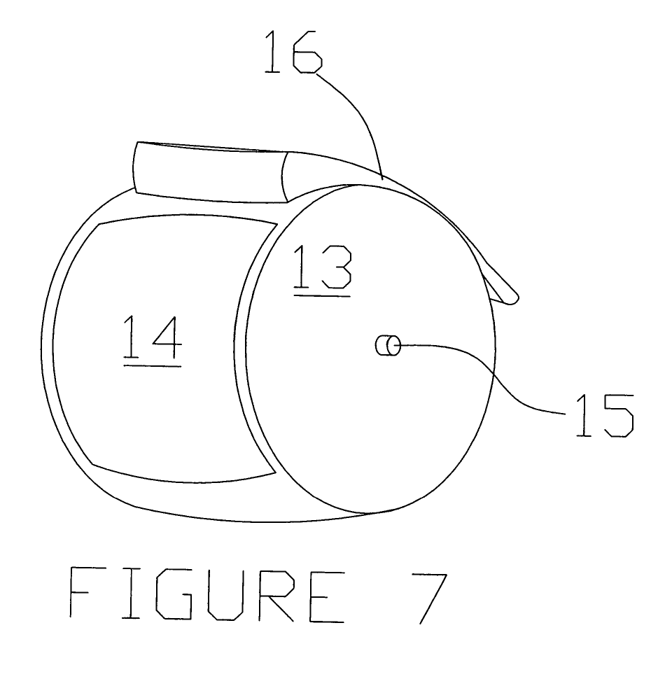

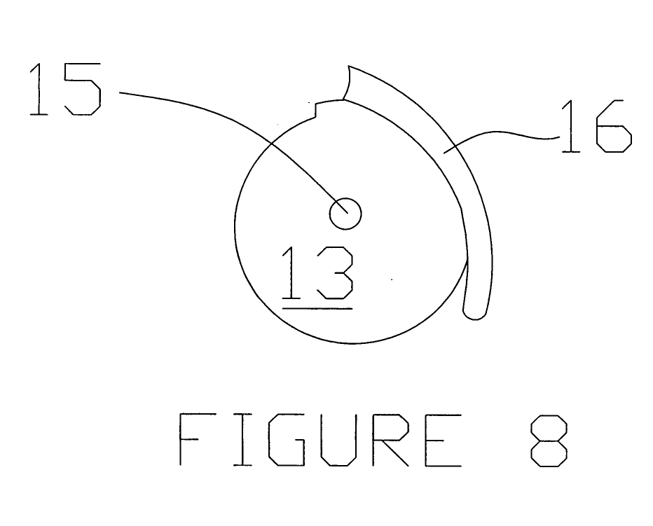

FIGS. 7 and 8 show the powder measure 13. The powder measure 13 includes recess 14 into which powder is deposited from the reservoir 2. During treatment, the user inserts the injured end of the toenail into the powder filled recess 14. Alternatively, the trimmer may pour a measured dosage of powder from the measure 13 onto a cut or tear in an animal's coat. Cylindrical extensions 15 mate with holes 5 as shown in previous figures to provide an axis of rotation about which the powder measure 13 rotates. Stop 16 is included on an exterior surface of the measure 13 and operates as mentioned above.

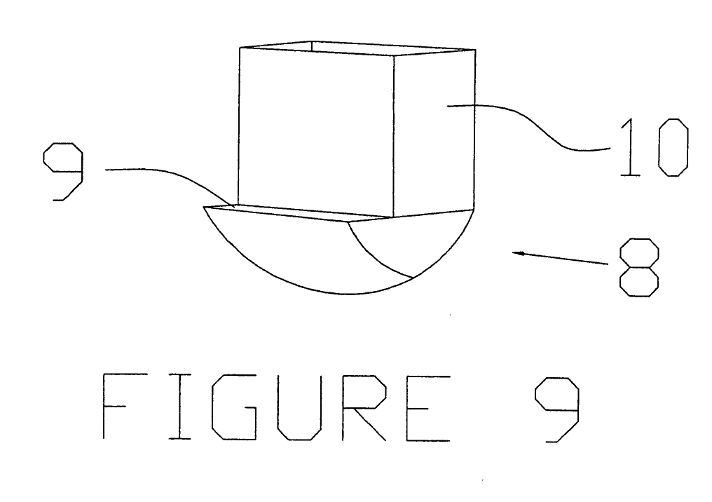

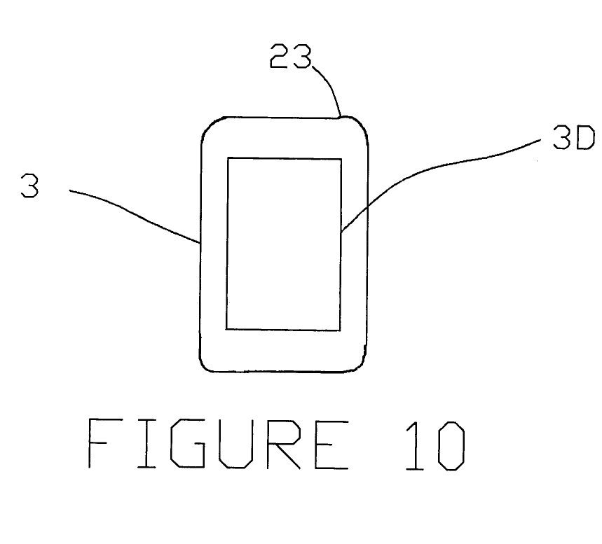

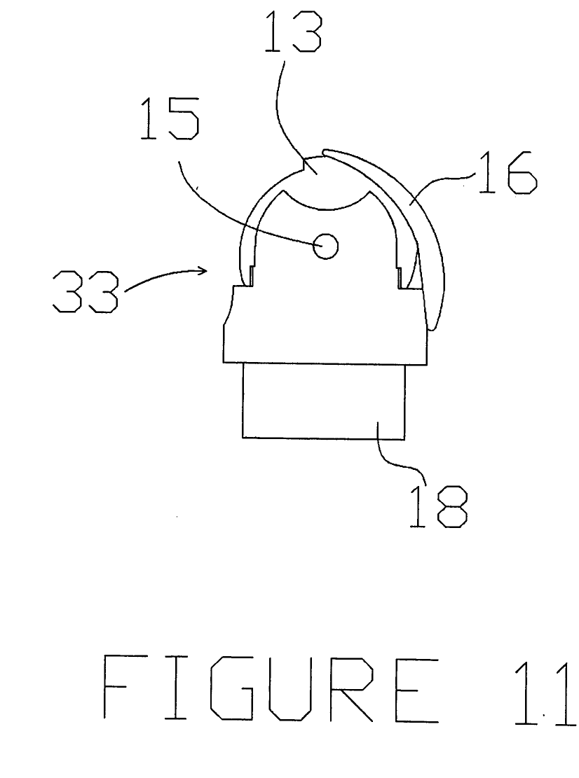

FIG. 9 is a perspective view of the a removable end cap 8 in another embodiment of the invention. The removable end cap 8 includes a complementary extension 10 that slides into and mates with the internal wall 3D (shown in FIG. 10) of the reservoir 2. A thumb edge 9 is included on the removable end cap 8 for assisting in removal of the end cap 8 from the reservoir 2. Small nubs or other bumps may be included on the complementary extension 10 for exerting greater pressure against the internal surface of the reservoir wall 3; thereby causing the end cap 8 to be more securely held in place. It should be noted that the removable end cap 8 is unnecessary for the third embodiment of the invention shown in FIG. 11.

FIG. 10 shows an end view of the powder reservoir 2. The exterior surface 3C of the reservoir wall 3 includes rounded corners in the preferred embodiments. However, it is easily recognizable that various interior and exterior shapes for the side walls 3 may be used to practice the invention. As shown, the interior surface 3D includes square-shape corners 24 in the preferred embodiment. The reservoir, as well as other parts of the invention, may be produced through known plastics molding techniques such as injection molding.

FIG. 11 shows a plan view of a removable powder measure 33 in the third embodiment of the invention. In this embodiment, the powder reservoir 2 includes only one open end. This end is shaped similar to the end that mates with the removable end cap 8 as shown above in the second embodiment. The removable powder measure 33 includes an extension 18 that is inserted into the open end of the reservoir 2. Thus, this extension 18 serves the same purpose as that one of the removable end cap 8. In this embodiment, the removable powder measure 33 includes all of the parts of the powder measure 3 of the previous embodiment. This particular embodiment lends itself for use in quickly treating a plurality of animals. The removable powder measure 33 can be quickly removed and replaced with ease to prevent the spread of disease among animals.

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention. Thus, it is to be understood that the invention is not limited to the exact construction illustrated and described above, but that various changes and modifications may be made without departing from the spirit and scope of the as defined by the following claims.

1. A powder dispenser comprising:
a powder reservoir for accepting and storing powder and having at least one open end;
an end cap for sealing the least one open end of said powder reservoir; and,
a rotatable powder measure including a recess for accepting powder from said powder reservoir and affixed at an end of said powder reservoir opposite said removable end cap.

2. The powder dispenser of claim 1 wherein said removable end cap further comprises a thumb extension for facilitating removal of the end cap from the powder reservoir.

3. The powder dispenser of claim 1 wherein said end cap includes a complementary extension for mating with the at least one open end of the powder reservoir.

4. The powder dispenser of claim 3 wherein said end cap includes a square extension for inserting into said at least one open end of the powder reservoir.

5. The powder dispenser of claim 4 further comprising an end cap including complementary mating extensions and powder reservoir recesses that accommodate the complementary mating extensions.

6. The powder reservoir of claim 1 wherein said powder measure includes a stop that prevents the powder measure from being over rotated.

7. The powder dispenser of claim 1 further comprising a hook for accepting a lanyard.

8. A powder dispenser for dispensing a measured amount of powder for treatment of an animal, said powder dispenser comprising:
a powder reservoir having at least one open end for receiving and dispensing powder therethrough; and,
a rotatable powder measure affixed at said at least one open end for dispensing a measured amount of powder from the powder reservoir.

9. The powder dispenser of claim 8 wherein said powder reservoir includes a first open end and a second open end.

10. The powder dispenser of claim 9 further including a cap removably affixed to said first end closing said powder reservoir.

11. The powder reservoir of claim 9 further comprising a cap hingeably affixed to said first end closing said powder reservoir.

12. The powder dispenser of claim 8 wherein said rotatable powder measure is removably affixed to said at least one open end such that the rotatable powder measure may be removed when the powder reservoir is filled with powder.

13. The powder dispenser of claim 8 wherein said powder reservoir includes holes and the rotatable powder measure includes complementary extensions for mating with the holes in said powder reservoir.

14. The powder dispenser of claim 8 further comprising a hook for accepting a lanyard.

15. A powder dispenser for dispensing a measured dosage of powder comprising:
a powder reservoir defined by walls and having at least one open end for receiving and dispensing powder therethrough; and
a powder measure affixed at the at least one open end of the powder reservoir, said powder measure comprising a recess having a volume for receiving a measured amount of powder from the powder reservoir.

16. The powder dispenser of claim 15 wherein at least two of said walls defining said powder reservoir includes holes and said powder measure includes circular extensions that mate with the holes in the at least two walls defining the powder reservoir.

17. The powder measure of claim 16 wherein said recess is exposed to an interior of the powder reservoir that contains powder when the powder measure is in a first position and rotated into a second position for dipping a dog toenail into powder filling said recess.

18. A method of treating a damaged dog toenail with a powder dispenser that comprises a powder reservoir and a rotatable powder measure, said method comprising:
filling a powder reservoir with powder for treating a damaged dog toenail;
causing a measured dosage of powder to flow from the powder reservoir into a recess in a rotatble powder measure;
rotating said powder measure to expose said measured dosage of powder for use; and,
dipping said damaged dog toenail into said measured dosage of powder to stop blood from flowing from the damaged dog toenail.

19. The method of claim 18 wherein said filling a powder reservoir includes passing power through an opening at an end of said reservoir.

20. The method of claim 18 wherein said method further includes filling a powder measure by rotating the powder measure to expose a recess therein to powder contained within said powder reservoir to allow powder to flow from said reservoir into said recess.
